(19) United States
(12) Patent Application Publication
(10) Pub. No.: US 2007/0260889 A1
(43) Pub. Date: Nov. 8, 2007

(54) Copy protection system for recording media

(75) Inventor: Gheorghe Sorin Stan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/579,416

(22) PCT Filed: Nov. 11, 2004
(86) PCT No.: PCT/IB04/52394

§ 371 Date: May 15, 2006

(30) Foreign Application Priority Data
Nov. 18, 2003 (EP) 03104249.2

(51) Int. Cl. G06F 12/14

(52) U.S. Cl. 713/193

(57) ABSTRACT

A method of reading data from a record medium (2) comprises the steps of: reading a first set of cryptographic data (3A) from a first predetermined storage location of the record medium; reading a second set of cryptographic data (3B) from a second predetermined storage location of the record medium; detecting a predefined correspondence between the first set of cryptographic data (3A) and the second set of cryptographic data (3B); outputting data only if said predefined correspondence is verified, otherwise inhibiting data output.

### FIELD OF THE INVENTION

The present invention relates in general to the field of recording data on a record carrier, especially disc-shaped carriers such as optical discs, magnetic discs, magneto-optical discs. In the following, the present invention will be explained particularly for the case of optical discs, but it is noted that this is not intended to restrict the scope of the invention to optical discs.

### BACKGROUND OF THE INVENTION

Optical discs, for example CD, DVD, are used for digitally storing data of different types such as, for example, computer data, computer programs, music, video, etc. Optical discs have been developed which allow a user to store his own data, but also optical discs are manufactured which contain pre-recorded data applied to the disc during the manufacturing process of the disc. Typically, in view of the information stored, such discs are relatively expensive, and it is tempting to copy such discs, in part or wholly, to another disc, especially since the quality of digital copies is as good as the quality of the original. Obviously, authors and vendors of computer programs, music, etc, will lose revenue if such copies are made, so there is a need for a copy protection system, i.e. a system to prevent information recorded on a disc from being copied to another disc. On the other hand, such a system should be such that playback of the original recording is not affected.

Typically, state of the art copy protection systems include some kind of code stored on the disc which needs to be retrieved during playback to serve cryptographic algorithms implemented inside the playback equipment. Illegally copying the disc contents involves circumventing the cryptographic algorithms once the code is known to the illegal user. In practice, because of cross-compatibility between various types of optical media and optical disc drives, it is possible to use modified drives to retrieve the codes embedded in copy-protected media.

Thus, it is an objective of the present invention to provide a new type of copy protection system which makes use of special optical disc drives to retrieve the copyright information. Such dedicated drives may be used, for example, in CD/DVD games consoles, while it will be practically impossible to play back the disc on legacy optical drives used as computer peripherals.

### SUMMARY OF THE INVENTION

According to an important aspect of the present invention, a disc drive comprises at least two pickup units which are capable of operating simultaneously, independently of each other.

According to another important aspect of the present invention, a disc contains at least two sets of cryptographic data which are stored in predetermined locations in a storage space of the disc. In a special case, the disc is an optical disc having two or more recording layers, one set of cryptographic data being recorded in a first one of said recording layers and another set of cryptographic data being recorded in a second one of said recording layers, a first one of said pickup units being arranged for reading said first one of said recording layers and a second one of said pickup units being arranged for reading said second one of said recording layers.

According to another important aspect of the present invention, the first pickup unit is controlled to read the data in a first one of said predetermined locations and simultaneously the second pickup unit is controlled to read the data in a second one of said predetermined locations. If the disc is an original recording, the output signals of the two pickup units will simultaneously contain the said two sets of cryptographic data.

According to another important aspect of the present invention, a signal processing circuit of a disc drive comprises a data flow controller unit which receives the data output of both pickup units. If the said two sets of cryptographic data are found substantially simultaneously in both data flows, the data flow controller unit allows both data flows to pass, otherwise both data flows are inhibited.

Thus, according to the invention, playback or read-out of a disc is always possible with a disc drive designed in accordance with the invention, and copying of the information to a copy disc is not inhibited. However, even when a full copy of the entire disc is made, it is very unlikely that the said two sets of cryptographic data are written to exactly the same predetermined locations. Thus, when the copy disc is played and the two pickup units are controlled to read the data in said predetermined locations, the said two sets of cryptographic data are not read simultaneously, and data output is inhibited by the data flow controller unit.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically illustrates a copy protection system;

FIG. 2 is a block diagram schematically showing elements of a control circuit.

### DESCRIPTION OF THE INVENTION

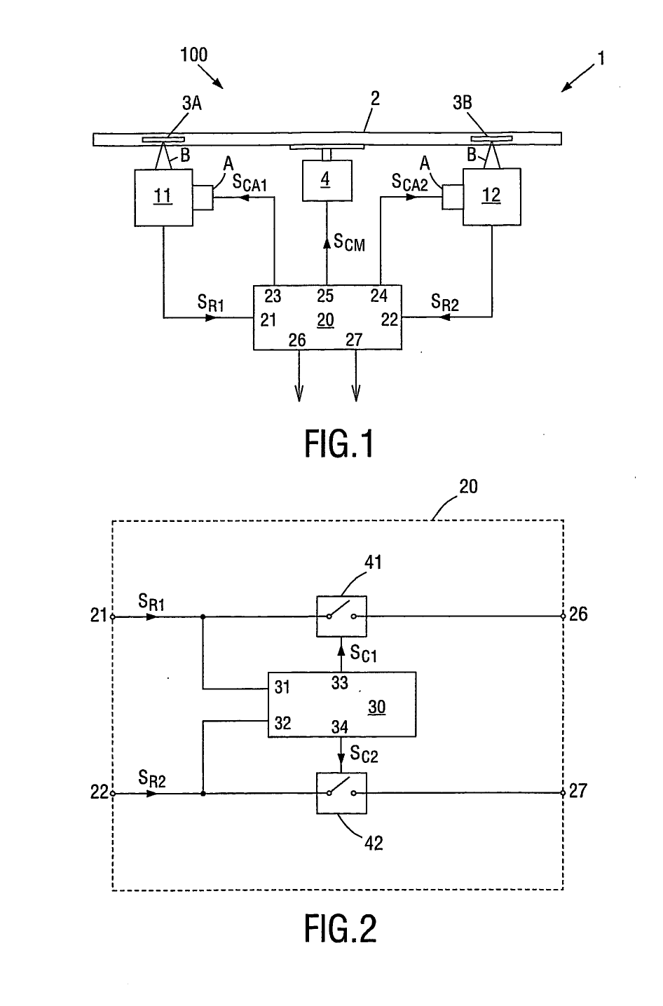

FIG. 1 schematically illustrates a copy protection system 100 in accordance with the present invention. Particularly, FIG. 1 schematically illustrates an optical disc drive apparatus 1 suitable for reading information from an optical disc 2, typically a DVD. For rotating the disc 2, the disc drive apparatus 1 comprises a motor 4 fixed to a frame (not shown for the sake of simplicity).

The disc drive apparatus 1 further comprises two optical pickup units (OPU) 11 and 12, each designed for scanning tracks (not shown) of the disc 2 by means of an optical beam B, typically a laser beam, and for producing read signals SR1 and SR2, respectively, representing the information read from disc. Since such OPUs are known per se, while the present invention does not relate to the design and functioning of such OPUs, it is not necessary here to discuss the design and functioning of an OPU in great detail.

Each OPU is associated with an actuator system A, comprising a radial actuator so that tracks can be followed, and a focus actuator for achieving and maintaining a correct focusing of the corresponding scan beam. Since such actuator systems are known per se, while the present invention does not relate to the design and functioning of such actuator systems, it is not necessary here to discuss the design and functioning of an actuator system in great detail.

The disc drive apparatus 1 further comprises a control circuit 20 having first and second data inputs 21 and 22 connected to receive the read signals SR1 and SR2, respectively, from the two OPUs 11 and 12.

Furthermore, the control circuit 20 has a first control output 23 coupled to a control input of the actuator system A of the first OPU 11, a second control output 24 coupled to a control input of the actuator system A of the second OPU 12, and a third control output 25 coupled to a control input of the motor 4. The control circuit 90 is designed to generate at its first control output 23 a first control signal S_{CA1} for controlling the actuator system A of the first OPU 11, to generate at its second control output 24 a second control signal S_{CA2} for controlling the actuator system A of the second OPU 12, and to generate at its third output 25 a third control signal S_{CM} for controlling the motor 4.

Furthermore, the control circuit 20 has first and second data outputs 26 and 27.

FIG. 2 is a block diagram, schematically showing some elements of the control circuit 20 in more detail. The control circuit 20 comprises two controllable switches 41 and 42, controlled by a data flow controller unit 30. The first controllable switch 41 has an input coupled to first input 21 of the control circuit 20 and has an output coupled to first output 26 of the control circuit 20. The second controllable switch 42 has an input coupled to second input 22 of the control circuit 20, and has an output coupled to second output 27 of the control circuit 20. Each switch has two operative conditions: an OPEN condition in which its output is coupled to its input, so that the switch provides an open data transfer path from input to output, and a CLOSED condition in which its output is disconnected from its input, so that the switch blocks the data transfer path from input to output. Thus, when a switch is in its OPEN condition, the corresponding read signal is passed without hindrance, but when a switch is in its CLOSED condition, transfer of the corresponding read signal is inhibited.

The data flow controller unit 30 has a first input 31 coupled to first input 21 of the control circuit 20, and has second input 32 coupled to second input 22 of the control circuit 20. Furthermore, the data flow controller unit 30 has first and second control outputs 33 and 34 coupled to control inputs of the first and second controllable switches 41 and 42, respectively.

The disc 2 comprises two sets of cryptographic copy protect data 3A and 3B. The disc may have one information layer only, or the disc may alternatively have two or more information layers. The two sets of cryptographic copy protect data 3A and 3B may be located in one and the same information layer, but, in the case of a multi-layer disc, the two sets of cryptographic copy protect data 3A and 3B are preferably located in different information layers. In any case, the two sets of cryptographic copy protect data 3A and 3B are stored in predetermined locations (addresses) on disc.

The operation of the copy protection system 100 is as follows.

The control circuit 20 is programmed to check the validity of the disc 2. This may be done at some time during an initialization procedure, or at regular time intervals during playback, or both.

In a validity check procedure, the control circuit 20 drives the two OPUs 11 and 12 to read the two sets of cryptographic copy protect data 3A and 3B simultaneously. Particularly, the first OPU 11 is moved to the track containing the location of the first set of cryptographic copy protect data 3A, and the second OPU 12 is moved to the track containing the location of the second set of cryptographic copy protect data 3B. Once both OPUs are in position, data is read from the corresponding tracks.

The data flow controller unit 30, receiving the read signals SR1 and SR2 at its two inputs 31 and 32, respectively, monitors these read signals SR1 and SR2 for the substantially simultaneous occurrence of said two sets of cryptographic copy protect data 3A and 3B.

If the disc 2 is a valid disc (original disc), the data streams in read signals SR1 and SR2, respectively, will contain the two sets of cryptographic copy protect data 3A and 3B substantially simultaneously, or at least with a maximum mutual delay which is less than half the revolution period of the disc. In response, the data flow controller unit 30 generates output signals SC1 and SC2, respectively, for controlling the controllable switches 41 and 42 to assume their OPEN condition.

If the disc 2 is a non-valid disc (copy disc), the two sets of cryptographic copy protect data 3A and 3B are probably located in physical locations not exactly corresponding to the said predetermined locations where they were originally located. Then, the data streams in read signals SR1 and SR2, respectively, may not contain any cryptographic copy protect data at all, or the two sets of cryptographic copy protect data 3A and 3B appear at too great a mutual time distance. In response, the data flow controller unit 30 generates output signals SC1 and SC2, respectively, for controlling the controllable switches 41 and 42 to assume their CLOSED condition.

After the validity check procedure, the control circuit 20 drives the two OPUs 11 and 12 back to their original locations to continue playback.

Thus, playback of an original disc is continued without interruption of the data output signal, but the data output signal is interrupted in the case of an illegal copy or with the use of legacy playback devices with one OPU that are not capable of processing the cryptographic information correctly.

It should be clear to those skilled in the art that the present invention is not limited to the exemplary embodiments discussed above, but that several variations and modifications are possible within the protective scope of the invention as defined in the appended claims.

In the above, the present invention has been explained with reference to block diagrams which illustrate functional blocks of the device according to the present invention. It is to be understood that one or more of these functional blocks may be implemented in hardware, where the function of such a functional block is performed by individual hardware components, but it is also possible that one or more of these functional blocks is or are implemented in software, so that the function of such a functional block is performed by one or more program lines of a computer program or a programmable device such as a microprocessor, microcontroller, digital signal processor, etc.

1. Method of reading data from a record medium (2), comprising the steps of:
reading a first set of cryptographic data (3A) from a first predetermined storage location of the record medium;
reading a second set of cryptographic data (3B) from a second predetermined storage location of the record medium;
detecting a predefined correspondence between the first set of cryptographic data (3A) and the second set of cryptographic data (3B);
outputting data only if said predefined correspondence is verified, otherwise inhibiting data output.

2. Method according to claim 1, wherein said predefined correspondence comprises a predetermined time relationship.

3. Method according to claim 2, wherein said predetermined time relationship means that the first set of cryptographic data (3A) and the second set of cryptographic data (3B) should be detected substantially simultaneously.

4. Method according to claim 3, wherein the step of reading said first set of cryptographic data (3A) and the step of reading said second set of cryptographic data (3B) are executed substantially simultaneously.

5. Method according to claim 1, wherein the step of reading said first set of cryptographic data (3A) and the step of reading said second set of cryptographic data (3B) are executed by two separate pickup units (11; 12).

6. Record medium (2), comprising a storage space with at least two sets of predetermined cryptographic copy protect data (3A, 3B) stored in predetermined storage locations.

7. Record medium according to claim 1, the record medium being an optical record medium, particularly an optical disc, comprising at least two storage layers, wherein the said two sets of predetermined cryptographic copy protect data (3A, 3B) are located in different storage layers.

8. Disc drive apparatus (1), comprising:
a first pickup unit (11) for reading data from a record medium (2) and generating a first read signal (SR1);
a second pickup unit (12) for reading data from the record medium (2) and generating a second read signal (SR2);
a first controllable switch (41) coupled in series with the output of the first pickup unit (11);
a second controllable switch (42) coupled in series with the output of the second pickup unit (12);
a data flow controller unit (30) having first and second data inputs (31, 32) coupled to the outputs of said first and second pickup units (11, 12), respectively, and having control outputs (33, 34) coupled to control inputs of said first and second controllable switches (41, 42), respectively;
the data flow controller unit (30) being designed to generate control signals for the first and second controllable switches (41, 42), respectively, in dependence on the contents of the data received at its two data inputs (31, 32).

9. Disc drive apparatus according to claim 8, wherein the data flow controller unit (30) is designed to switch said first and second controllable switches (41, 42) to an OPEN condition if the data flow controller unit (30) receives a predetermined first set of cryptographic data (3A) and a predetermined second set of cryptographic data (3B) fulfilling a predefined correspondence, and to otherwise switch said first and second controllable switches (41, 42) to a CLOSED condition.

10. Disc drive apparatus according to claim 9, wherein said predefined correspondence comprises a predetermined time relationship.

11. Disc drive apparatus according to claim 10, wherein said predetermined time relationship means that the first set of cryptographic data (3A) and the second set of cryptographic data (3B) should be detected substantially simultaneously.

12. Disc drive apparatus according to claim 8, comprising a controller (20) for controlling actuators (A) associated with said pickup units (11, 12), the controller (20) being designed to control said actuators (A) so as to bring said pickup units (11, 12) substantially simultaneously to predefined first and second storage locations of the record medium (2) in order to substantially simultaneously read said first set of cryptographic data (3A) and said second set of cryptographic data (3B).

13. Disc drive apparatus according to claim 8, the disc drive apparatus being an optical disc drive apparatus.

14. Copy protection system (1), comprising:
a record medium (2), comprising a storage space with at least two sets of predetermined cryptographic copy protect data (3A, 3B) stored in predetermined storage locations;
and a disc drive apparatus (1) according to claim 8.
